(19) United States
(12) Patent Application Publication
(10) Pub. No.: US 2011/0087401 A1
(43) Pub. Date: Apr. 14, 2011

(54) Intelligent Driver License for Vehicle Start-Up System

(76) Inventor: Chien-Hua TSAO, Shanghai (CN)

(21) Appl. No.: 12/577,388

(22) Filed: Oct. 12, 2009

(51) Int. Cl. B60R 25/00; B60Q 1/00

(52) U.S. Cl. 701/36; 340/439

(57) ABSTRACT

A vehicle start-up system includes an intelligent driver license, a control device, and a plurality of display devices. The control device and a plurality of display devices are mounted on the vehicle. Driver can start the start-up system by inserting the intelligent driver license into the control device. If the driver violates the speed limit or other traffic rules, points are recorded on the intelligent driver license by the control device or by law enforcement officers' handheld devices and the record is transmitted to the intelligent driver license and DMV database by the control device of the handheld devices. If the points recorded for the intelligent driver license is over a specified limit, driver will not be able to start a vehicle with this license.

### BACKGROUND OF THE INVENTION

1. Field of the Invention

This invention relates to an intelligent driver license for vehicle start-up system that can replace current driver license to record violation point according to the driving behavior of the driver and store the remaining driver point therein.

2. Description of the Prior Art

According to reports from World Health Organization (WHO), 1.27 million people are killed by traffic accidents every year worldwide. Forty-six percent are pedestrians and bicycle or motorcycle riders. This means every country's traffic policy usually benefits car drivers and lack the proper protection for vulnerable road users. Sixty-three percent of the ninety thousand deaths for traffic accident in China are vulnerable road users. The dangers for vulnerable road users are not only because they don't have the protection from the “Shell” but also because many countries plan and design roads and constructions for cars to move fast and lack the consideration for pedestrians and riders.

Since cars are the most dangerous threat to pedestrians and riders, less than one-third of the 178 countries in this poll match the least requirement of reduced speed limit in city area, less than ten percent countries effectively control speed limit, forty-four percent countries do not have the policy to encourage public transportation to replace provide vehicles. Only one-third of the population lives in countries having policy encouraging walking and riding bicycle to replace mobile vehicle. The low-income countries own 48% of the world's motor vehicles but consume more than 90% of the death-related traffic accidents. As motor vehicles keep growing in developing countries, if the situation remains, it is estimated there will be 2.4 million people worldwide being killed by traffic accidents by the year 2030.

Regarding the rising death rate, 90% are caused by improper operation of the drivers and currently there is no better solution to avoid this ‘modern disasters’. Take car drivers for an example. When the drivers violate traffic rules, they were stopped by law enforcement officers to check their driver licenses and give tickets according to the violations. This method has the warning effect on the drivers but it is not enough. So the driver point method is adopted in many countries according to their needs to process the traffic violations of the drivers, but even this driver violation point method works only for the driver himself. If the violation point of the vehicle is close to six, the driver's driver license is revoked, or he/she has no driver license, the driver should not operate a vehicle. Unfortunately, we cannot tell if the driver next to us is a good driver or a dangerous driver; and when taking a bus or taxi, we usually just get in by chance without knowing will the driver drives safely or not. These uncertainties usually result in the increase of the traffic accident and the decrease of safety, wasting time for officers on traffic redirection or control. This is a great lost for public benefits.

So as to know, the current known practice has lot of drawbacks, is not a good design, and must be improved.

Noticing the disadvantages of the current method mentioned the inventor of this invention dedicates to improvement and invention. After years of hard working, this invention of start-up system for intelligent driver license is successfully invented.

### SUMMARY OF THE INVENTION

The primary objective of this invention is to provide an intelligent driver license for vehicle start-up system to improve drivers' driving habits and for the driver to be more responsible for his/her own driving behavior.

The further objective of this invention is to provide an intelligent driver license for vehicle start-up system to help us make sure the driver of the vehicle next to us is a good driver, and to minimize traffic accident and improve drivers' safety.

The invention of the intelligent driver license for vehicle start-up system which includes the intelligent driver license, a control device, and plurality of display devices can achieves these objectives. The control device and the plurality of display devices are mounted on the vehicle. The control device contains a control module, a reading module, a display module, and an input module. The driver can insert the intelligent driver license into the control device or carrying it and input the driving code, conjunction with the ignition key of the vehicle to start the vehicle.

When the driver starts the vehicle, the three indicator lights on the plurality of display devices connected to the control device will be on or off according to the driver's violation points stored in the intelligent driver license to indicate the driver's driving record for if he is a good driver without point or has too many violation points.

The control device may also have a data transmit module and connect to the speed sensor via the vehicle computer. When the driver is driving too fast or violating traffic rules, his violation point is accumulated by the control device or law enforcement officers' handheld device, and the record is transmitted to the DMV database and the driver's intelligent driver license by the same device. Also if the points on the intelligent driver license are more than a limit, the driver will not be able to start a vehicle with it.

### BRIEF DESCRIPTION OF THE DRAWINGS

FIG. 1. shows the system diagram of this invention of an intelligent driver license for vehicle start-up system;

FIG. 2. shows the system diagram of this invention of an intelligent driver license for vehicle start-up system with data transmission device;

FIG. 3. shows the system diagram of this invention of an intelligent driver license for vehicle start-up system with speed detection device;

FIG. 4. shows the system diagram of this invention of an intelligent driver license for vehicle start-up system with handheld device;

FIG. 5. shows A: an usage example of this invention of an intelligent driver license for vehicle start-up system;
shows B: an usage example of this invention of an intelligent driver license for vehicle start-up system;

FIG. 6. shows the control device application flow chart of this invention of an intelligent driver license for vehicle start-up system;

FIG. 7. shows the speeding respond flow chart of this invention of an intelligent driver license for vehicle start-up system; and

FIG. 8. shows the law enforcement officials processing flow chart of this invention of an intelligent driver license for vehicle start-up system.

### DETAILED DESCRIPTION OF THE PREFERRED EMBODIMENT

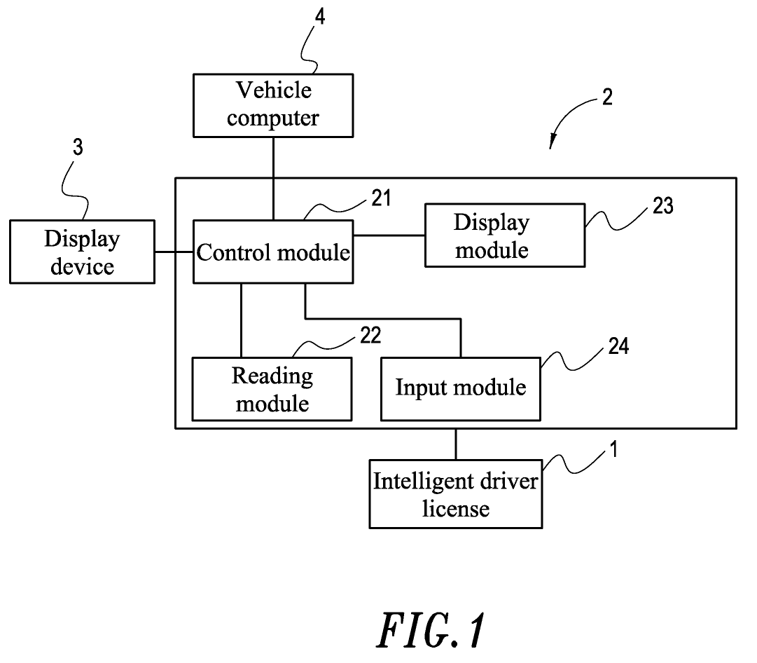

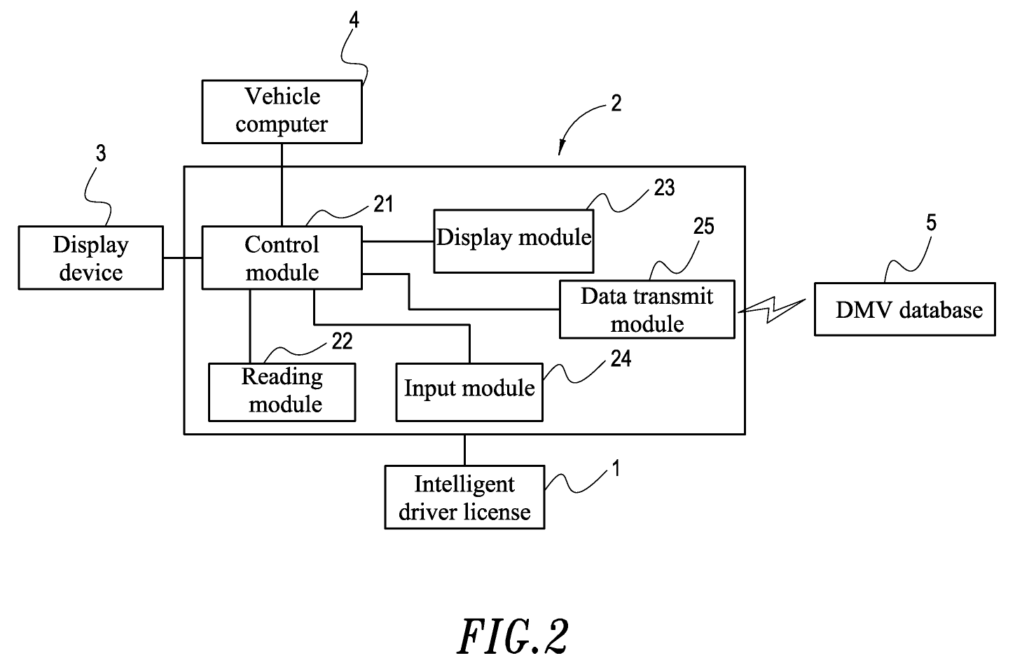

Please refer to FIG. 1 for the system diagram of this invention of an intelligent driver license for vehicle start-up system. As seen in the figure, the system includes:

an intelligent driver license 1 which can be read by a control device 2 and stores the driver's data and violation points;

the control device 2 mounted on the vehicle and including a control module 21, a reading module 22, a display module 23, and a input module 24. The driver can start the vehicle by inserting the intelligent driver license 1 into the control device 2 or by carrying the intelligent driver license 1 and key-in the driving passcode, in associate with an inserted ignition key. This driving passcode and ignition key can be configured according to the vehicle so the driver may be required to input the passcode just once and no need in the future to start the vehicle, or can start the vehicle with just the intelligent driver license and no need to insert the ignition key;

a plurality of display devices 3 mounted on the vehicle and connected to the control device 2. The plurality of display devices 3 have three indicator lights respectively to display different lights according to the violation points stored on the intelligent driver license and to indicate the record on the intelligent driver license for if the driver is a poor driver with multiple points or a good driver with no point; and

the control device 2 whose control module 21 is connected to a vehicle computer 4, a plurality of display devices 3, a reading module 22, and an input module 24, to receive data from the intelligent driver license 1. And conjunction with correct passcode input from the input module 24, the driver's data and violation points are displayed on the display module 23. If the violation points on the intelligent driver license 1 are over a limit, the driver will not be able to start the vehicle.

Please refer to FIG. 2 for the system diagram of this invention of an intelligent driver license for vehicle start-up system with data transmission device. The control device 2 uses a control module 21 to connect to a data transmit module 25 which links to the DMV database 5. When driver starts the vehicle, the control device 2 can transmit the driver's record to the intelligent driver license 1 and DMV database 5 via the data transmit module 25. The DMV database 5 can be connected to the DMVs worldwide so the driver's record can be retrieved worldwide to avoid driver's dangerous behavior around the world. The transmission to the DMV database 5 uses wireless transmission whose mechanism includes Bluetooth and IR. The control device 2 may be equipped with GPS for locating the position of the vehicle which can automatically cell for help in case of emergency or accident to accelerate the aid.

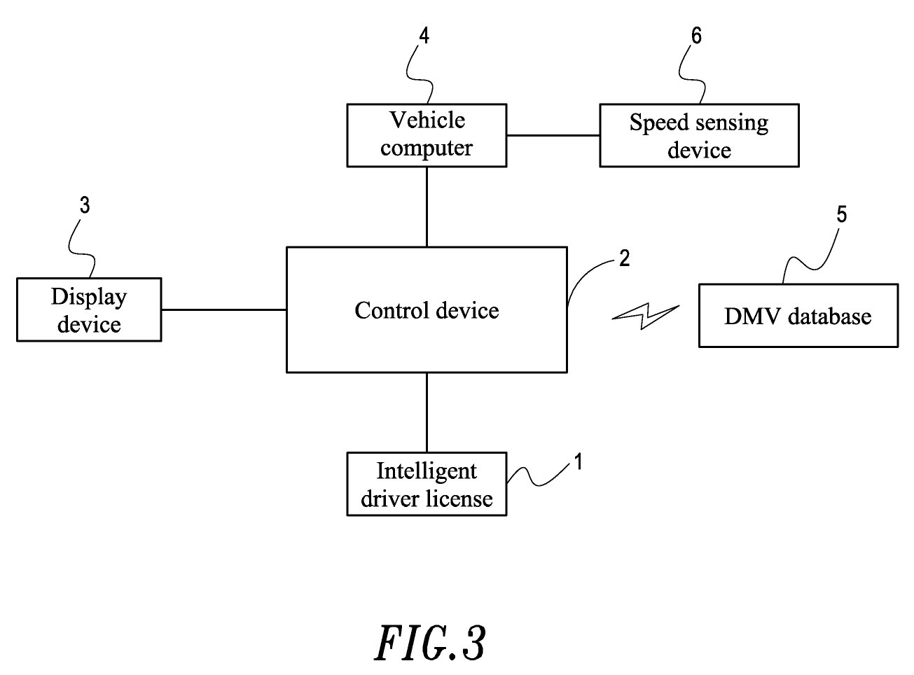

Please refer to FIG. 3 for the system diagram of this invention of an intelligent driver license for vehicle start-up system with speed detection device, whose control device 2 can link to a speed sensing module 6 via a vehicle computer 4. The speed sensing module 6 transmits the driving speed to the control device 2 through the vehicle computer 4 and when the speed is too fast, the control device 2 will notify the driver by sound beep. If the driver ignores it, the system can add violation point to the intelligent driver license 1 through the control device 2 and notify the driver of the result by sound beep of the control device 2 then accumulates the points on the intelligent driver license 1 and transmit the result to the DMV database 5. If the violation points on the intelligent driver license 1 are over a set threshold, the driver cannot use the intelligent driver license 1 to start a vehicle. In associated with government's violation point regulation, the license can be suspended for a month if having certain points in a given time period, or be revoked if has been suspended twice in a year and gain more violation point.

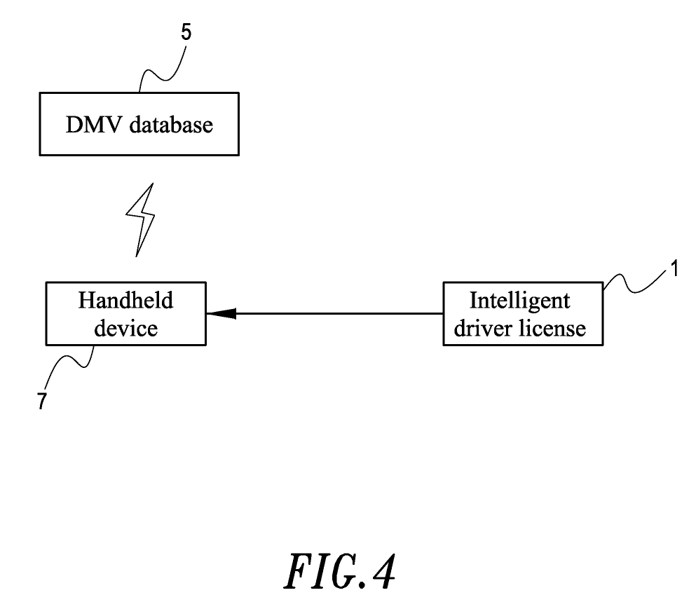

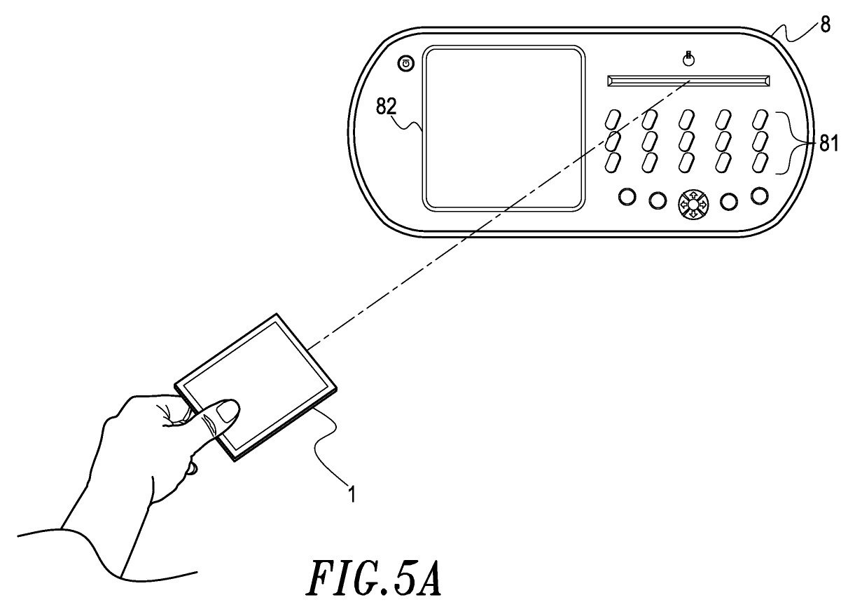

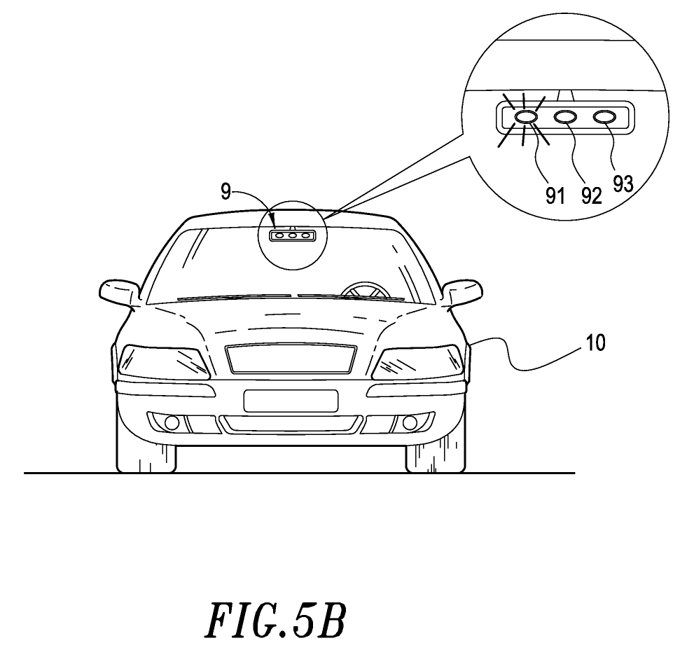

Please refer to FIG. 4 for the system diagram of this invention of an intelligent driver license for vehicle start-up system with handheld device, which includes:

an intelligent driver license 1 which can be read by handheld device 7 and stores the driver data and violation points;

a DMV database 5 which links to the handheld device 7 to store the driver's driving record;

a handheld device 7 which connects to the intelligent driver license 1 and the DMV database 5. If the driver violates the traffic rules and is stopped by law enforcement officer, the officer uses handheld device 7 to accumulate violation points on the driver's intelligent driver license 1 and the handheld device 7 transmits the result to the intelligent driver license 1 and the DMV database 5. If the violation points stored in the intelligent driver license 1 are more than a limit, the driver cannot start a vehicle with this intelligent driver license 1.

Pleas refer to FIG. 5 A and FIG. 5 B for usage examples of this invention of an intelligent driver license for vehicle start-up system. As seen in the figures, driver can use the control device 8 to read the intelligent driver license 1 and key in the driving passcode on the input keypad 81, with the ignition key inserted in the vehicle 10 to start the vehicle 10. After the vehicle 10 is started, the driver's data and accumulated violation points are displayed on the display screen 82. The control device 8 will display the violation status on the display device 9 according to the violation points. The display device 9 has three status indicator lights: good driver indicator light 91, average driver indicator light 92, and dangerous driver indicator light 93. The lights are determined by the violation points. For example, if the points are 0 to 2, blinking the good driver indicator light 91; if the points are 3 to 4, blinking the average driver indicator light 92; and if the points are 5 to 6, linking the dangerous driver indicator light 93. The display device 9 can be added to the vehicle 10 by the buyer or the seller when the vehicle 10 is sold.

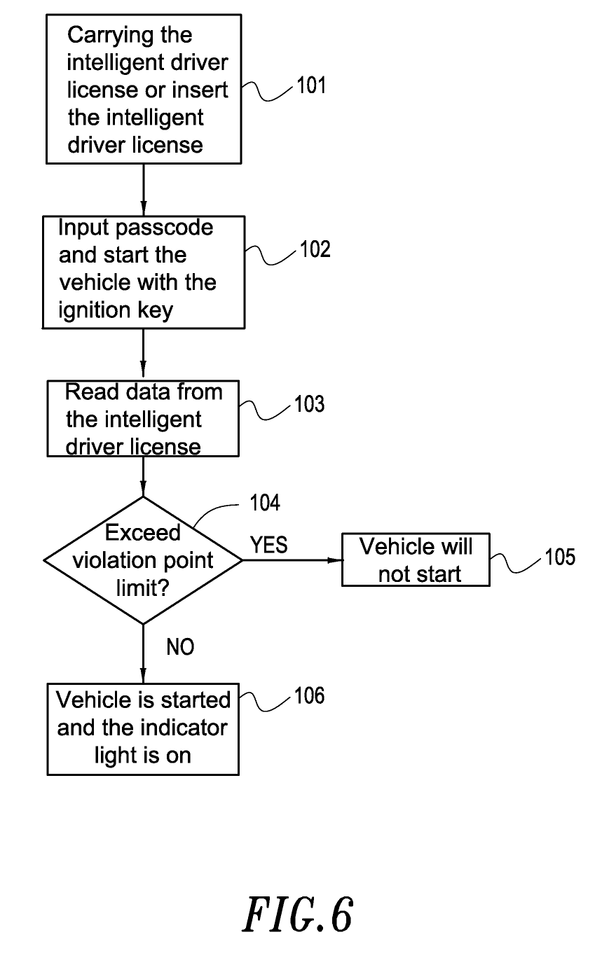

Please refer to FIG. 6 for the control device application flow chart of this invention of an intelligent driver license for vehicle start-up system.
1) The driver can carry the intelligent driver license or insert the intelligent driver license into the control device 101, input passcode, and start the vehicle with the ignition key 102.
2) The control device reads data from the intelligent driver license that contains the driver data and violation points 103.
3) The control device will determine the violation points 104 and if the points are more than a preset limit, the vehicle will not start 105.
4) If the points do not exceed the limit, the vehicle is successfully started and the indicator light is on 106.

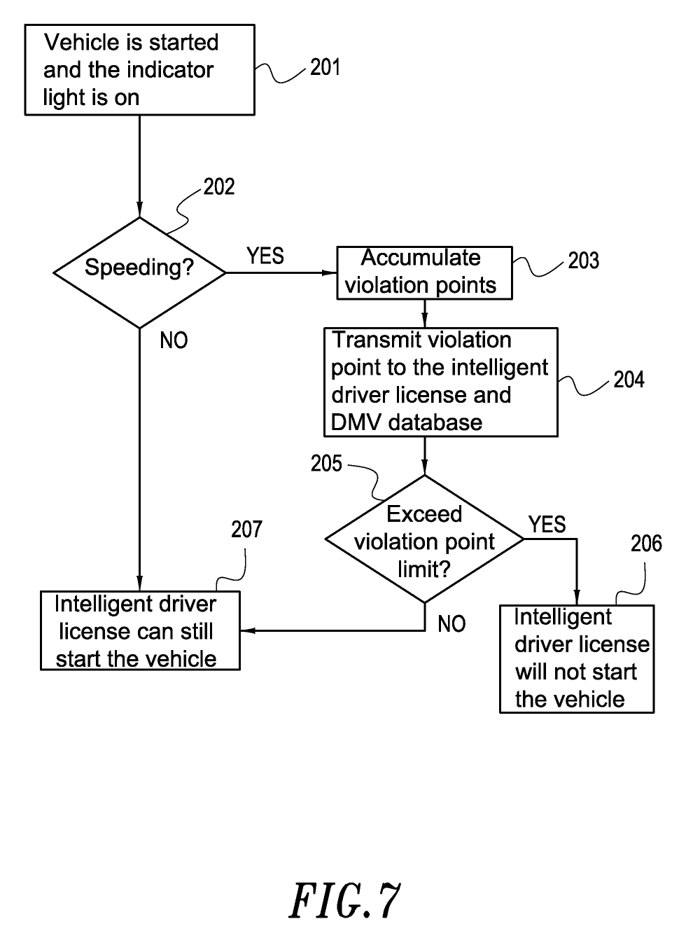

Please refer to FIG. 7 for the speeding respond flow chart of this invention of an intelligent driver license for vehicle start-up system.
1) The vehicle is started and the indicator light is on 201.
2) The control device will determine if the vehicle is speeding 202. If the vehicle is driven too fast, the control device will first notify the driver and sound beeping. If the driver ignores, violation point is accumulated on the intelligent driver license by the control device 203. The control device will notify the driver of this result and transmit the data to the intelligent driver license and DMV database 204.
3) The control device will determine the violation points on the intelligent driver license again to see if it exceeds the limit 205. The driver will not be able to start the vehicle with this intelligent driver license if the violation points are more than the limit 206.
4) If the driving speed and the violation points are under the limits, the driver can still use the intelligent driver license to start the vehicle 207.

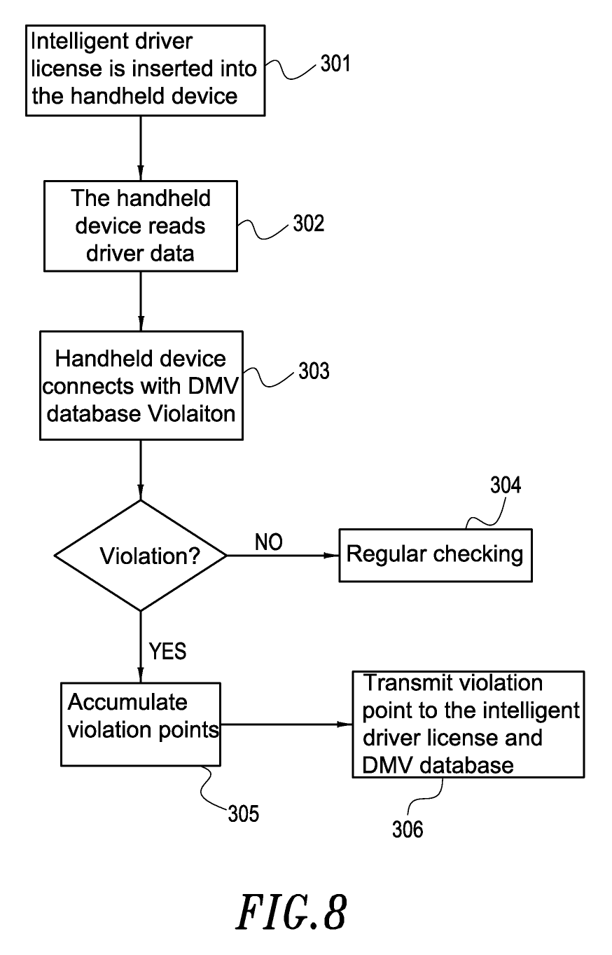

Please refer to FIG. 8 for the law enforcement officials processing flow chart of this invention of an intelligent driver license for vehicle start-up system.
1) When the law enforcement officials stop a vehicle to perform checking, they can insert the intelligent driver license into the handheld device 301.
2) The handheld device reads driver data and violation points on the intelligent driver license 302 and links to the DMV database to confirm the data 303.
3) If the driver does not stop for violation, regular checking is performed 304.
4) When violation occurs, the law enforcement officials use the handheld device to add violation points to the intelligent driver license 305 and the handheld device transmits violation points to the intelligent driver license and DMV database 306.

The intelligent driver license for vehicle start-up system in this invention has the following advantages over current technology:
1. This invention of an intelligent driver license for vehicle start-up system can help driver maintain good driving habit and be more responsible for own behavior, can also avoid unlicensed driving.
2. This invention of an intelligent driver license for vehicle start-up system can help us identify if other drivers are good drivers and to minimize traffic accident and increase safe driving.
3. This invention of an intelligent driver license for vehicle start-up system can help passengers of public transportation understand the driver status of good driver, average driver, or dangerous driver to provide more opportunity for the passengers.
4. This invention of an intelligent driver license for vehicle start-up system must accompany intelligent driver license, driving passcode, and ignition key to start the vehicle as to avoid drivers without the intelligent driver license to start the vehicle.
5. This invention of an intelligent driver license for vehicle start-up system can require different insurance rate according to driver's violation points. Drivers with more violation points tend to have higher risk so the insurance rate would be higher.
6. This invention of an intelligent driver license for vehicle start-up system whose control device can be equipped with GPS positioning device to gain satellite positioning of the vehicle and can automatically initiate the emergency aid when accident occurs.

The aforementioned descriptions are solely for explaining the embodiments of the present invention and are not intended to limit the scope of the present invention. Any equivalent practice of modification within the spirit of the present invention should be treated as being within the scope of patent of the present invention.

As aforementioned, the present invention is novel in technology and advantaged in many effects that the prior arts lack. The present invention conforms to the novelty and non-obviousness of patentability. Please the examiner carefully considering the application of the present invention and allowing the application.

What is claimed is:

1. A vehicle start-up system, comprising:
an intelligent driver license which can be read by a control device and stores driver data and violation points;
the control device which is mounted on the vehicle and driver capable of starting the vehicle by inserting the intelligent driver license into the control device, entering an driving passcode, and inserting an ignition key of the vehicle; and
a plurality of display devices mounted on the vehicle and connected to the control device to display record of the intelligent driver license.

2. The vehicle start-up system as claimed in claim 1, wherein the intelligent driver license can be carried by the driver and with entering the driving passcode and inserting the vehicle ignition key to start the vehicle.

3. The vehicle start-up system as claimed in claim 1, wherein the control device can have a GPS positioning unit to position the vehicle with satellite.

4. The vehicle start-up system as claimed in claim 1, wherein the plurality of display devices have three indicator lights to display different light according to the violation points stored on the intelligent driver license.

5. The vehicle start-up system as claimed in claim 1, wherein the control device has at least a control module, a reading module, a display module, and an input module.

6. The vehicle start-up system as claimed in claim 5, wherein the control device is linked to a vehicle computer, the plurality of display devices, the reading module, the input module, and a data transmit module to receive data from the intelligent driver license and by entering the correct passcode on the input module to display the driver data and violation points on the display device.

7. The vehicle start-up system as claimed in claim 6, wherein the vehicle computer is linked to a speed sensing device which transmits driving speed to the control device through the vehicle computer; and when the vehicle is driven too fast, the control device is configured to notify and sound beeping; and if the driver ignores, the control device is configured to add violation points to the intelligent driver license, notify the driver by sound, then transmit the result of the violation points to the intelligent driver license and DMV database.

8. The vehicle start-up system as claimed in claim 5, wherein the control device can have a data transmit module to transmit data to the intelligent driver license and DMV database.

9. The vehicle start-up system as claimed in claim 8, wherein the data transmit module uses wireless transmission mechanism of Bluetooth or IR.

10. The vehicle start-up system as claimed in claim 1, wherein the intelligent driver license can be read by handheld devices and the handheld device is linked to the intelligent driver license and DMV database; and when the driver is stopped by law enforcement officials for violation, the officer uses the handheld device to accumulate violation points on the intelligent driver license and the handheld device transmits the result to the intelligent driver license and the DMV database; and if the violation points on the intelligent driver license are over a limit, the driver is not able to start the vehicle with the intelligent driver license.

11. An intelligent identification start-up method comprising steps of:
1) starting a vehicle by a driver by carrying an intelligent driver license or inserting it into the control device, inputting the driving passcode, and inserting an ignition key of the vehicle;
2) reading data from the intelligent driver license and determining the violation points by a control device; and if the violation points are more than a limit, the vehicle is configured to not start;
3) successfully starting the vehicle if the violation points are not over a limit, and a driver status indicator being on.

12. The intelligent identification start-up method as claimed in claim 11, wherein the control device can be connected to a speed sensing device through a vehicle computer and the speeding determination process includes steps of:
1) starting the vehicle and the driver status indicator light being on;
2) determining driving speed by the control device, and when the vehicle is driven too fast, the control device accumulates violation points in the intelligent driver license and transmits the result to the intelligent driver license and DMV database;
3) determining the violation points by the control device, and when the points are more than a limit, the driver is not be able to start the vehicle with the intelligent driver license;
4) starting a vehicle by the driver with the intelligent driver license if the driving speed is under the speed limit and the violation points are under the limit.

13. The intelligent identification start-up method as claimed in claim 12, wherein the control device is configured to notify the driver with sound when driving too fast, and when the driver ignores, the control device accumulates violation points on the intelligent driver license and transmit the result to the intelligent driver license and the DMV database.

14. The intelligent identification start-up method as claimed in claim 12, wherein the intelligent driver license can be read by law enforcement official's handheld devices, and law enforcement officials perform checking in the process of:
1) using the handheld device to read the driver data and violation points on the intelligent driver license and link to the DMV database to confirm;
2) when the driver does not stop for violation, performing a regular checking;
3) when violation occurs, using the handheld device by the law enforcement officials to add violation points to the intelligent driver license and the handheld device transmits violation points to the intelligent driver license and DMV database.
